(19) United States
(12) Patent Application Publication
(10) Pub. No.: US 2025/0262638 A1
(43) Pub. Date: Aug. 21, 2025

(54) NOZZLE AND SLOT COATER INCLUDING THE SAME

(71) Applicant: SAMSUNG SDI CO., LTD., Yongin-si (KR)

(72) Inventors: Jaesoon JANG, Yongin-si (KR); Heechan JUNG, Yongin-si (KR)

(21) Appl. No.: 18/957,410

(22) Filed: Nov. 22, 2024

(30) Foreign Application Priority Data
Feb. 15, 2024 (KR) 10-2024-0022095

(51) Int. Cl. B05C 5/02; H01M 4/04

(52) U.S. Cl. CPC B05C 5/0262; H01M 4/0411

(57) ABSTRACT

A nozzle and a slot coater including the same are disclosed. A nozzle includes: a first body portion and a second body portion that are coupled to each other; a discharge portion between the first body portion and the second body portion and configured to discharge a slurry supplied from an outside onto a substrate; and an area varier inside at least one of the first body portion and the second body portion and configured to change an area of a portion in contact with the slurry discharged through the discharge portion.

### CROSS-REFERENCE TO RELATED APPLICATION

The present application claims priority to and the benefit of Korean Patent Application No. 10-2024-0022095, filed on Feb. 15, 2024 in the Korean Intellectual Property Office, the entire disclosure of which is incorporated herein by reference.

### BACKGROUND

### 1. Field

Aspects of embodiments of the present disclosure relate to a nozzle and a slot coater including the same.

### 2. Description of the Related Art

A rechargeable battery may be fabricated into various shapes. Among these, a pouch battery includes an electrode assembly with an insulating separator between positive and negative electrode plates, and a thin flexible pouch with the electrode assembly built in. In this case, the pouch accommodates the electrode assembly in an inner space.

In the manufacture of the electrode plate, a coating process is performed in which a slurry mixed with an active material, a binder, a conductive material, and a solvent are coated on a current collector. Such a coating method is a generally used method for manufacturing electrode plates due to its ability to produce thin and uniform films at high speed.

The slurry generated through the mixing process is distributed in a width direction inside the slot coater and applied on the current collector transferred through a nozzle. In this case, the shape of a part of the nozzle closest to the current collector may have a significant impact on thickness planarity of an applied slurry solution.

### SUMMARY

According to an aspect of one or more embodiments of the present disclosure, a nozzle that can change an area of a portion in contact with a slurry, and a slot coater including the same, are provided.

However, technical aspects and objects of the present disclosure are not limited to the above-mentioned aspects and objects, and other aspects and objects can be clearly understood by a person of an ordinary skill in the art from the description of the invention described below.

According to one or more embodiments, a nozzle includes: a first body portion and a second body portion that are coupled to each other; a discharge portion between the first body portion and the second body portion and configured to discharge a slurry supplied from an outside onto a substrate; and an area varier inside at least one of the first body portion and the second body portion and configured to change an area of a portion in contact with the slurry discharged through the discharge portion.

The area varier may include: a moving roller; a first driver configured to move the moving roller; one or more of fixed rollers arranged apart from the moving roller; and a belt member, or belt, that is wound on the moving roller and the fixed roller, and the area of the portion in contact with the slurry changes as the moving roller moves in a direction by the first driver.

A part of the belt may be exposed to the discharge portion.

The first driver may be adjacent to the discharge portion.

The moving roller may perform a straight-line reciprocal motion to be away from the discharge portion or closer to the discharge portion.

The at least one of the first body portion and the second body portion provided with the area varier may include a first guide portion that guides the moving roller to perform a straight-line reciprocal motion.

The area varier may include a guide protrusion that is protruded from a side surface of the moving roller and inserted in the first guide portion.

The first guide portion may be in a portion of one of the first body portion and second body portion, adjacent to the substrate, and parallel with the substrate.

The first guide portion may have a shape of a slot.

The area varier may further include a support member that has a shape of a plate and arranged in a portion of the belt, adjacent to the discharge portion.

The support member may be in contact (e.g., close contact) with the belt.

The nozzle may further include a tension adjuster provided with the area varier among the at least one of the first body portion and the second body portion, is adjacent to the belt, and configured to adjust a tension of the belt by pressing a side of the belt member.

The tension adjuster may include: a pressure roller that presses a side of the belt; and a second driver configured to move the pressure roller such that the pressure roller presses the belt member or becomes away from the belt member.

The one or more fixed rollers of the area varier may include a plurality of fixed rollers, and the pressure roller of the tension adjuster may be arranged to press a portion of the belt located between two adjacent fixed rollers among the plurality of fixed rollers.

Among the first body portion and the second body portion, a portion in which the tension adjuster is provided may include a second guide portion that guides the pressure roller to perform a straight-line reciprocal motion

The second guide portion may have a shape of a slot.

The area varier may be provided in each of the first body portion and the second body portion.

According to one or more embodiments, a slot coater includes: a transferer to transfer a substrate; a nozzle to discharge a slurry to the substrate; and a supplier to supply the slurry to the nozzle.

According to one or more embodiments, a slot coater including a nozzle can apply a slurry with a target thickness on a substrate by varying the area of a portion in contact with the slurry with the area variable unit. Therefore, even if a design of the electrode plate changes, the coating process can be continuously performed without interruption, which improves productivity and reduces manufacturing costs.

### BRIEF DESCRIPTION OF THE DRAWINGS

The following drawings attached to the specification illustrate some embodiments of the present disclosure, and are provided to allow the technical spirit of the present disclosure to be better understood together with the detailed description of the present disclosure described below. However, the present disclosure is not be construed as limited to matters described with reference to the drawings.

FIG. 1 is a perspective view of a slot coater including a nozzle according to an embodiment.

FIG. 2 is a perspective view of a nozzle according to an embodiment.

FIG. 3 is a cross-sectional view of the nozzle according to an embodiment.

FIG. 4 is a cross-sectional view of a state in which an area variable unit of the nozzle in FIG. 3 operates.

FIG. 5 is a cross-sectional view of a state in which an area variable unit is provided in both of a first body portion and a second body portion, according to an embodiment.

FIG. 6 is a cross-sectional view of an area variable unit according to an embodiment.

### DESCRIPTION OF SYMBOLS

| | |
|---|---|
| 10: slot coater | 20: transfer unit |
| 30: supply unit | 100: nozzle |
| 110: first body portion | 120: second body portion |
| 131: discharge portion | 140: area variable unit |
| 141: first driving member | 142: moving roller |
| 143: fixed roller | 144: belt member |
| 145: guide protrusion | 146: support member |
| 150: tension adjustment unit | 151: pressure roller |
| 152: second driving member | G1: first guide portion |
| G2: second guide portion | |

### DETAILED DESCRIPTION

Herein, some example embodiments of the present disclosure will be described in further detail with reference to the accompanying drawings. However, the terms or words used in this specification and ranges described below should not be construed as being limited to conventional or dictionary meanings, and are to be interpreted as having meaning and concept consistent with the technical idea of the present invention based on the principle that it can be appropriately defined as a concept of a term to describe an inventor's own invention in the best way. Therefore, embodiments described in the present specification and the configurations shown in the drawings are provided as example embodiments of the present invention, and do not necessarily represent all the technical spirit of the present invention, and, therefore, it is to be understood that various equivalents and modifications may be substituted for them at the time of filing the present application.

In addition, the terms “comprise” or “include” and/or “comprising” or “including” used in the present disclosure may specify the presence of stated shapes, numerals, steps, operations, members, elements, and/or a group thereof, and do not preclude the presence or addition of one or more other shapes, numerals, steps, operations, members, elements, and/or groups thereof.

Further, the accompanying drawings may not be illustrated to scale, and sizes of some components may be exaggerated to assist in the understanding of the present disclosure. In addition, the same reference numerals may be assigned to the same components in different embodiments.

It is to be understood that two objects of comparison may be the same or substantially the same when referred to as “the same.” Therefore, “substantially the same” may include a deviation which is considered low in the art, for example, a deviation of 5% or less. In addition, the fact that a parameter is in a predetermined region may indicate that the parameter is uniform from an average perspective.

Expressions such as “first,” “second,” and the like may be used to indicate various components, and do not limit the corresponding components. These terms are used to distinguish one component and another component from each other, and a first component may also be a second component unless specifically stated to the contrary.

Throughout the specification, each element may be one element or a plurality of elements unless specifically stated to the contrary.

It is to be understood that when a component is referred to as being disposed “on the top (or bottom) of” or “above (or below)” another component, the component may be disposed “on the top (or bottom) of” another component, or may have one or more third components interposed between a component and any component disposed above (or below) another component.

In addition, when a component is described to be disposed “on,” “connected to,” or “coupled to” another component, it is to be understood that a component may be directly coupled or connected to another component, has one or more third components “interposed” therebetween, or is “in contact with,” “coupled to,” or “connected to” another component through the one or more third components.

The term “and/or” used herein includes any one or all combinations of the associated listed items. In addition, the use of “may” when describing the embodiments of the present disclosure relates to “one or more embodiments of the present disclosure.” Expressions such as “one or more” preceding a list of elements may modify the entire list of elements and may not modify individual elements of the list.

Throughout the specification, when referring to “A and/or B,” A, B, or A and B is indicated, unless specifically stated to the contrary, and when referring to “C to D”, C or more and D or less is indicated, unless specifically stated to the contrary.

A phrase may refer to any and all suitable combinations when the phrase such as “at least one of A, B, and C”, “at least one of A, B, or C”, “at least one selected from the group A, B, and C” or “at least one selected from A, B, and C” is used to specify a list of the elements A, B, and C.

The term “use” may be considered synonymous with a term “utilize.” As used herein, a term “substantially,” “about,” or a similar term may be used as a term of approximation rather than a term of degree, and used to consider an inherent variation in a measured or calculated value which is to be recognized by those skilled in the art.

Although the terms “first,” “second,” “third,” or the like may be used herein to describe various elements, components, regions, layers, and/or sections, these elements, components, regions, layers, and/or sections are not to be limited by these terms. These terms may be used to distinguish one element, component, region, layer, or section from another element, component, region, layer, or section. Accordingly, a first element, component, region, layer, or section discussed below may be named a second element, component, region, layer, or section without departing from the teachings of the embodiments.

For ease of explanation, a spatial relative term such as “beneath,” “below,” “lower,” “above,” “upper,” or the like may be used herein to describe a relationship between one element or feature and another element(s) or feature(s), as shown in the drawings. A spatial relative location is to be understood to encompass a different direction of a device in use or operation in addition to a direction thereof shown in the drawings. For example, when the device in the drawing is turned over, an element described as “beneath” or “below” another element may be understood to be “on” or “above” another element. Therefore, the term “below” may encompass both upward and downward directions.

The terms used herein are intended to describe embodiments of the present disclosure and are not intended to limit the present disclosure.

Herein, referring to the drawings, before describing a nozzle according to an embodiment, a slot coater including the nozzle will be described in further detail.

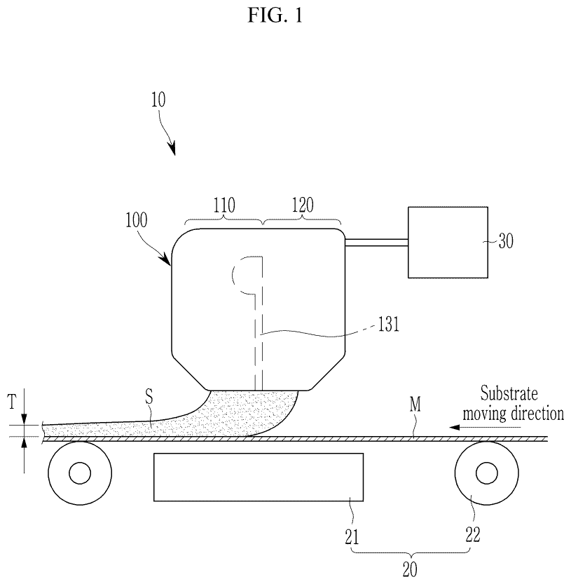

FIG. 1 is a perspective view of a slot coater including a nozzle according to an embodiment.

Referring to FIG. 1, a slot coater 10 may include a transfer unit 20, a nozzle 100, and a supply unit 30.

The transfer unit 20 transfers a substrate M. The transfer unit 20 may include a stage 21 and a plurality of rollers 22. The substrate M may be a current collector used to manufacture, for example, an electrode plate. However, the substrate M may be used to manufacture an active material layer in the form of a film, but is not limited thereto.

The nozzle 100 discharges a slurry S to the substrate M. The nozzle 100 may be disposed adjacent to the stage 21. The nozzle 100 may include a buffer portion 132 and a discharge portion 131. The slurry S supplied from the outside to the nozzle 100 may be filled in the buffer portion 132 and then discharged to the substrate M through the discharge portion 131.

The supply unit 30 supplies the slurry S to the nozzle 100. In an embodiment, the above-described slurry S may be manufactured by mixing an active material, a binder, a conductive material, and a solvent.

The slurry S supplied to the nozzle 100 by the supply unit 30 is distributed in a width direction inside the nozzle 100 and applied on the current collector transferred through the nozzle 100. In this case, an area closest to the current collector on a lower side of the nozzle 100 may have an influence (e.g., a significant influence) on a thickness planarity of the slurry S solution applied on the substrate M.

A lower area of the nozzle 100 according to an embodiment may change based on a direction shown in the drawing, and, thus, the slot coater 10 may apply the slurry S solution on the substrate M to a target thickness T. The nozzle 100 will be described in further detail with reference to the drawing.

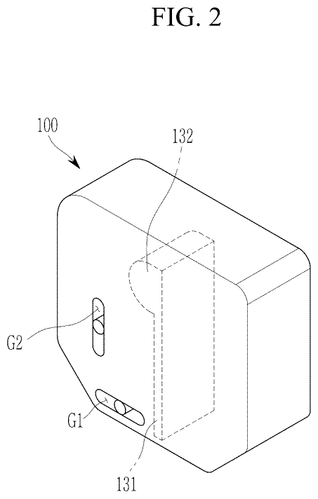

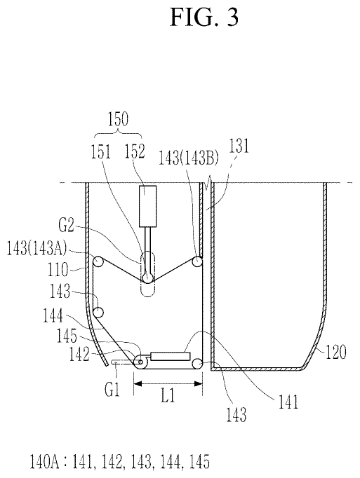

FIG. 2 is a perspective view of a nozzle according to an embodiment; and FIG. 3 is a cross-sectional view of the nozzle according to an embodiment.

Referring to FIG. 2 and FIG. 3, the nozzle 100 according to an embodiment includes a first body portion 110, a second body portion 120, the discharge portion 131, and an area variable unit, or area varier, 140A.

The first body portion 110 and the second body portion 120 are coupled to each other. In an embodiment, the first body portion 110 and the second body portion 120 may be a body of the nozzle 100. The buffer portion 132 may be located in either the first body portion 110 or the second body portion 120. The buffer portion 132 allows the slurry supplied through the supply unit 30 to flow in the width direction of the nozzle 100 and may store a certain amount of the slurry.

The discharge portion 131 is disposed between the first body portion 110 and the second body portion 120 and discharges slurry supplied from the outside to the substrate. The discharge portion 131 may communicate with the above-described buffer portion 132.

The area variable unit 140A is installed inside one or more of the first body portion 110 and the second body portion 120, and changes the area of a portion in contact with the slurry discharged through the discharge portion 131.

It is illustrated in FIG. 1 that the area variable unit 140A is installed in the first body portion 110, but the area variable unit 140A may be installed in the second body portion 120. Herein, the description will be made assuming that the area variable unit 140A is installed in the first body portion 110.

The area variable unit 140A may include, for example, a moving roller 142, a first driving member, or first driver, 141, a fixed roller 143, and a belt member, or belt, 144.

The moving roller 142 may press a portion of the belt member 144, which will be described later. The moving roller 142 may be moved in a straight-line reciprocal movement to be away from the discharge portion 131 or closer to the discharge portion 131.

The first driving member 141 moves the moving roller 142. The first driving member 141 may be disposed adjacent to the discharge portion 131, but the first driving member 141 is not limited thereto.

The fixed roller 143 is disposed apart from the moving roller 142. The fixed roller 143 may be provided as one or more.

The belt member 144 is wound on the moving roller 142 and the fixed roller 143. The belt member 144 may not be rotated by the moving roller 142 and the fixed roller 143, and may remain tightly wound on the moving roller 142 and the fixed roller 143.

A region of the belt member 144 in contact with the slurry may change as the moving roller 142 moves in a direction by the first driving member 141.

In an embodiment, referring to FIG. 3, when the moving roller 142 moves to the right by the first driving member 141, an area L1 of a region in contact with the slurry may be reduced.

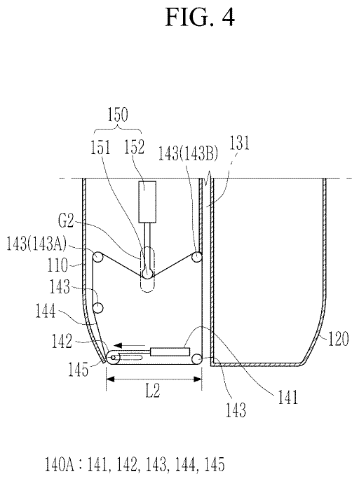

In an embodiment, referring to FIG. 4, when the moving roller 142 moves to the left by the first driving member 141, an area L2 of the region in contact with the slurry may be increased.

A portion of the belt member 144 may be installed to be exposed to the discharge portion 131. With reference to the direction shown in FIG. 3, the slurry may be moved downward along a portion disposed vertical in the bent member 144, while being adjacent to the discharge portion 131.

As described above, the area variable unit 140A may vary an area of the portion in contact with the slurry discharged from the discharge portion 131. Therefore, when repeated experiments are conducted and a shape (e.g., area) of the nozzle 100 optimized or improved for the thickness of the slurry applied to the substrate is confirmed, a user may input a corresponding target area into the slot coater 10.

The slot coater 10 controls the area variable unit 140A, and the area variable unit 140A may change the area of the portion in contact with the slurry to the input target area.

Among the first body portion 110 and the second body portion 120, one in which the area variable unit 140A is installed may have a first guide portion G1. The first guide portion G1 may guide movement of the moving roller 142 such that the moving roller 142 performs straight-line reciprocal motion.

A shape of the first guide portion G1 for this may be, for example, a slot shape. In an embodiment, the first guide portion G1 is disposed adjacent to the substrate in one of the first body portion 110 and the second body portion 120 and is disposed parallel to the substrate.

In an embodiment, the above-described area variable unit 140A may include a guide protrusion 145.

The guide protrusion 145 protrudes from a side surface the moving roller 142 and is inserted into the first guide portion G1. As described, since the guide protrusion 145 is inserted into the first guide portion G1, the moving roller 142 may reduce the stress generated by the tension of the belt member 144. In addition, the guide protrusion 145 may ensure that the moving roller 142 moves stably.

The nozzle 100 according to an embodiment may further include a tension adjustment unit, or tension adjuster, 150.

The tension adjustment unit 150 is installed in one of the first body portion 110 and the second body portion 120 where the area variable unit 140A is installed, is disposed adjacent to the belt member 144, and presses a side of the belt member 144 to adjust the tension of belt member 144.

The tension adjustment unit 150 may include, for example, a pressure roller 151 and a second driving member 152.

The pressure roller 151 presses a side of the belt member 144. The fixed roller 143 of the area variable unit 140A may be provided in plural. In an embodiment, the pressure roller 151 of the tension adjustment unit 150 may be disposed to press a portion of the belt member 144 disposed between two adjacent fixed rollers 143A and 143B among the plurality of fixed rollers 143.

The second driving member 152 moves the pressure roller 151 such that the pressure roller 151 may press the belt member 144 or be away from the belt member 144.

In an embodiment, among the first body portion 110 and the second body portion 120, one where the tension adjustment unit 150 is installed may include a second guide portion G2. For example, when the tension adjustment unit 150 is installed in the first body portion 110, the second guide portion G2 may also be provided in the first body portion 110.

In an embodiment, the second guide portion G2 guides the pressure roller 151 to perform straight-line reciprocal motion. In an embodiment, the second guide portion G2 may have a slot shape.

When the pressure roller 151 is disposed in the first body portion 110, the second guide portion G2 may be disposed to cross the upper and lower direction of the first body portion 110. Accordingly, the pressure roller 151 moves in an up-and-down direction by the second driving member 152 and presses the belt member 144, and, thus, the belt member 144 may maintain a target tension.

Here, the target tension of the belt member 144 may be a tension that allows the slurry to be stably discharged through the discharge portion 131. However, the target tension of the belt member 144 may change depending on a design of the nozzle 100, and is not limited to a specific value.

The tension adjustment unit 150 may be connected (e.g., electrically connected) to the area variable unit 140A and may be operated in conjunction with the area variable unit 140A. In an embodiment, when the moving roller 142 of the area variable unit 140A is moved to a position adjacent to the discharge portion 131 and a contact area between the slurry and the belt member 144 is reduced, the tension adjustment unit 150 moves the pressure roller 151 to the belt member 144. Accordingly, the tension of the belt member 144 may be maintained.

When the moving roller 142 of the area variable unit 140A is moved to a position away from the discharge portion 131 and the contact area between the slurry and the belt member 144 is increased, the tension adjustment unit 150 moves the pressure roller 151 in a direction away from the belt member 144. Accordingly, the tension of the belt member 144 may be continuously maintained.

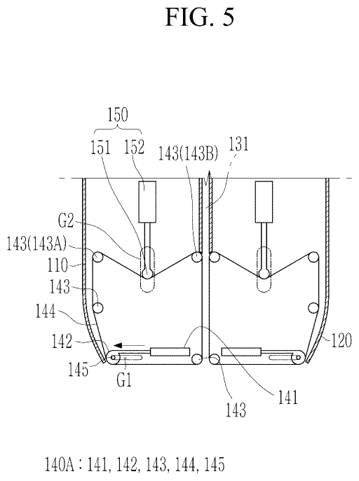

FIG. 5 is a cross-sectional view of an embodiment in which the area variable unit is provided in both of the first body portion and the second body portion.

Referring to FIG. 5, the above-described area variable unit 140A may be installed in each of the first body portion 110 and the second body portion 120. The area variable unit 140A is provided in both the first body portion 110 and the second body portion 120, and contact areas of both the left-hand side and the right-hand side that are in contact with the slurry at the bottom of the nozzle 100 may be varied.

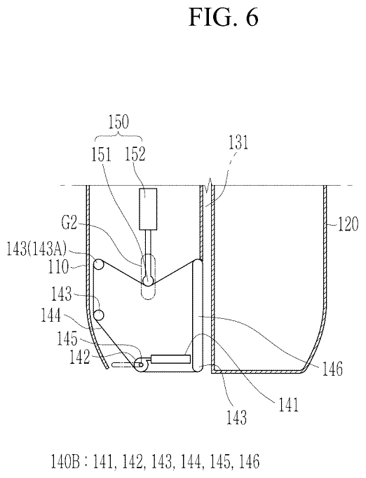

FIG. 6 is a cross-sectional view of the area variable unit according to an embodiment.

Referring to FIG. 6, an area variable unit 140B according to an embodiment may further include a support member 146.

In an embodiment, the support member 146 has a plate shape and is disposed adjacent to the discharge portion 131 in the belt member 144. The support member 146 may be disposed to be in contact (e.g., close contact) with the belt member 144.

The support member 146 may be disposed to be in contact (e.g., close contact) with a portion of the belt member 144, exposed to the discharge portion 131. Accordingly, in a process of discharging the slurry through the discharge portion 131, the exposed portion of the belt member 144 to the discharge portion 131 may be prevented or substantially prevented from bending. Therefore, the area variable unit 140B according to an embodiment may discharge the slurry stably.

In a coating process of applying a slurry solution to a substrate using a slot coater using a conventional nozzle, the shape of the nozzle optimized for the thickness of the slurry applied to the substrate needs to be found to manufacture an electrode plate to be mounted on a specific rechargeable battery and the entire slot coater needs to be manufactured to fit the nozzle. Therefore, it takes a lot of cost and time to manufacture a slot coater. In addition, the coating process may be stopped while replacing the existing slot coater with a new slot coater.

However, referring to FIG. 3 and FIG. 4, as described above, the slot coater 10 including the nozzle 100 according to an embodiment may apply the slurry with a target thickness on the substrate by varying the area of the portion in contact with the slurry with the area variable unit 140A.

Therefore, the slot coater 10 including the nozzle 100 according to an embodiment can continuously carry out the coating process without stopping the coating process even if a design of the electrode plate is changed, thereby improving productivity and reducing manufacturing costs.

Although some example embodiments of the present disclosure have been described above, the accompanying drawings and detailed description of the present disclosure described above are merely illustrative and provided to explain the present disclosure, and are not intended to limit the meaning or scope of the present disclosure set forth in the claims. Therefore, it is to be understood by those skilled in the art that various modifications and other equivalent embodiments may be derived from the present disclosure. Accordingly, a technical scope of the present disclosure is to be defined by the technical spirit of the claims.

What is claimed is:

1. A nozzle comprising:
a first body portion and a second body portion that are coupled to each other;
a discharge portion between the first body portion and the second body portion and configured to discharge a slurry supplied from an outside onto a substrate; and
an area varier inside at least one of the first body portion and the second body portion and configured to change an area of a portion in contact with the slurry discharged through the discharge portion.

2. The nozzle as claimed in claim 1, wherein the area varier comprises:
a moving roller;
a first driver configured to move the moving roller;
at least one fixed roller arranged apart from the moving roller; and
a belt that is wound on the moving roller and the fixed roller, and the area of the portion in contact with the slurry changes as the moving roller moves in a direction by the first driver.

3. The nozzle as claimed in claim 2, wherein a part of the belt is exposed to the discharge portion.

4. The nozzle as claimed in claim 2, wherein the first driver is adjacent to the discharge portion.

5. The nozzle as claimed in claim 2, wherein the moving roller performs a straight-line reciprocal motion to be away from the discharge portion or closer to the discharge portion.

6. The nozzle as claimed in claim 2, wherein, the at least one of the first body portion and the second body portion provided with the area varier comprises a first guide portion that guides the moving roller to perform a straight-line reciprocal motion.

7. The nozzle as claimed in claim 6, wherein the area varier comprises a guide protrusion that is protruded from a side surface of the moving roller and inserted in the first guide portion.

8. The nozzle as claimed in claim 6, wherein the first guide portion is located in a portion of one of the first body portion and the second body portion, adjacent to the substrate, and is parallel with the substrate.

9. The nozzle as claimed in claim 6, wherein the first guide portion has a shape of a slot.

10. The nozzle as claimed in claim 2, wherein the area varier further comprises a support member having a shape of a plate and located in a portion of the belt, adjacent to the discharge portion.

11. The nozzle as claimed in claim 10, wherein the support member is in contact with the belt.

12. The nozzle as claimed in claim 2, further comprising a tension adjuster provided with the area varier among the at least one of the first body portion and the second body portion, located adjacent to the belt member, and configured to adjust a tension of the belt by pressing a side of the belt.

13. The nozzle as claimed in claim 12, wherein the tension adjuster comprises:
a pressure roller configured to press a side of the belt; and
a second driver configured to move the pressure roller such that the pressure roller presses the belt or becomes away from the belt.

14. The nozzle as claimed in claim 13, wherein
the at least one fixed roller of the area varier comprises a plurality of fixed rollers, and
the pressure roller of the tension adjuster is arranged to press a portion of the belt located between two adjacent fixed rollers among the plurality of fixed rollers.

15. The nozzle as claimed in claim 13, wherein, among the first body portion and the second body portion, a portion in which the tension adjuster is provided comprises a second guide portion that guides the pressure roller to perform a straight-line reciprocal motion.

16. The nozzle as claimed in claim 15, wherein the second guide portion has a shape of a slot.

17. The nozzle as claimed in claim 1, wherein the area varier is provided in each of the first body portion and the second body portion.

18. A slot coater comprising:
a transferer to transfer a substrate;
a nozzle to discharge a slurry to the substrate; and
a supplier to supply the slurry to the nozzle,
wherein the nozzle is the nozzle as claimed in claim 1.
